(19) United States
(12) Patent Application Publication
(10) Pub. No.: US 2026/0300054 A1
(43) Pub. Date: Oct. 1, 2026

(54) Asynchronous Multi-Agent Communication

(71) Applicant: GDM Holding LLC, Mountain View, CA (US)

(72) Inventors: Victor Carbune, Zurich (CH); Florian Nils Hartmann, Zurich (CH)

(21) Appl. No.: 19/095,834

(22) Filed: Mar. 31, 2025

(51) Int. Cl. G06F 9/54

(52) U.S. Cl. CPC G06F 9/546

(57) ABSTRACT

Systems and methods for asynchronous multi-agent communication can include accessing a current set of context data elements associated with a multi-agent communication session. The method can include generating, by a first agent, a first agent output data element of a first agent output based on the current set of context data elements. The method can include receiving from one or more second agents, one or more data streams including one or more second agent output data elements of one or more second agent outputs generated by the one or more second agents. The method can include, before completion of the first agent output, updating the current set of context data elements to include the one or more second agent output data elements and generating one or more additional first agent output data elements of the first agent output based on the current set of context data.

### FIELD

The present disclosure relates generally to training or controlling an artificial intelligence agent to communicate asynchronously. More particularly, the present disclosure relates to training or controlling machine-learned models to stream and receive intermediate messages as a message is being decoded to facilitate asynchronous communications with other machine-learned models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes accessing, by a first agent of a plurality of agents, a current set of context data elements associated with a multi-agent communication session involving the plurality of agents. The method includes generating, by the first agent, a first agent output data element of a first agent output based on the current set of context data elements, the first agent output including a sequence of multiple first agent output data elements decoded over a plurality of decoding iterations. The method includes, before completion of the first agent output, receiving by the first agent, from one or more second agents of the plurality of agents, one or more data streams including one or more second agent output data elements of one or more second agent outputs generated by the one or more second agents of the plurality of agents. The method includes, before completion of the first agent output, updating by the first agent, the current set of context data elements to include the one or more second agent output data elements. The method includes generating, by the first agent, one or more additional first agent output data elements of the first agent output based on the current set of context data.

In some implementations, updating, by the first agent, the current set of context data elements to include the one or more second agent output data elements includes inserting the one or more second agent output data elements into the current set of context data elements in a sequence according to a time of receipt of the second agent output data elements.

In some implementations, updating, by the first agent, the current set of context data elements to include the one or more second agent output data elements includes interleaving the one or more second agent output data elements with one or more of the first agent output data elements of the first agent output.

In some implementations, the one or more second agents includes two or more different agents. In some implementations, updating by the first agent, the current set of context data elements to include the one or more second agent output data elements includes interleaving second agent output data elements received from the two or more different agents.

In some implementations, the method includes, before the completion of the first agent output, streaming, by the first agent, the first agent output data element of the first agent output to one or more of the plurality of agents.

In some implementations, the method includes, before the completion of the first agent output, updating a key-value (KV) cache based on the first agent output data element and the one or more second agent output data elements. In some implementations, the KV cache is associated with the sequence of multiple first agent output data elements and a sequence of multiple second agent output data elements decoded over the plurality of decoding iterations.

In some implementations, the method includes grouping the one or more second agent output data elements of one or more second agent outputs based on an originating agent of the one or more second agents.

In some implementations, the method includes determining, based on a maximum length, a complete second agent output by the one or more second agents.

In some implementations, the method includes determining, based on a termination data element of the one or more second agent output data elements, a complete second agent output by the one or more second agents. In some implementations, the termination data element is indicative of an end of a sequence of the one or more second agent output data elements.

Another example aspect of the present disclosure is directed to a computing system. The system can include one or more processors and one or more non-transitory computer-readable media storing instructions that, when implemented, cause the computing system to perform operations. The system can include a first agent configured to participate in a multi-agent communication session involving the first agent and one or more second agents. The operations can include accessing, by the first agent, a current set of context data elements associated with the multi-agent communication session. The operations can include initiating, by the first agent, decoding of a first agent output based on the current set of context data elements, wherein decoding of the first agent output includes generating a sequence of multiple first agent output data elements. The operations can include during decoding of the first agent output, streaming, by the first agent, individual elements of the first agent output data elements to the one or more second agents as they are generated.

In some implementations, the operations can include receiving, by the first agent, from one or more second agents, one or more data streams including one or more second agent output data elements of one or more second agent outputs generated by the one or more second agents.

In some implementations, the operations can include updating, by the first agent, the current set of context data elements to include the one or more second agent output data elements.

In some implementations, updating, by the first agent, the current set of context data elements to include the one or more second agent output data elements includes inserting the one or more second agent output data elements into the current set of context data elements in a sequence according to a time of receipt of the second agent output data elements.

In some implementations, streaming, by the first agent, individual elements of the first agent output data elements to the one or more second agents as they are generated includes interleaving at least one individual element of the first agent output data elements.

In some implementations, the operations include during decoding of the first agent output, updating a key-value (KV) cache based on the current set of context data elements and the first agent output data element and the sequence of multiple first agent output data elements.

In some implementations, the individual elements of the first agent output data elements include a termination data element, wherein the termination data element is indicative of an end of a sequence of the first agent output data elements.

In some implementations, accessing, by the first agent, a current set of context data elements associated with the multi-agent communication session includes exchanging information with the one or more second agents, the information indicative of (i) a common task associated with the one or more second agents, and (ii) respective agents of the one or more second agents that are participating in the multi-agent communication session.

Another example aspect of the present disclosure is directed to a computing system. The system can include one or more processors and one or more non-transitory computer-readable media storing instructions that, when implemented, cause the computing system to perform operations. The system can include a first agent configured to participate in a multi-agent communication session involving the first agent and one or more second agents. The operations can include accessing, by the first agent, a current set of context data elements associated with the multi-agent communication session. The operations can include initiating, by the first agent, decoding of a first agent output based on the current set of context data elements, wherein decoding of the first agent output includes generating a sequence of multiple first agent output data elements. The operations can include during decoding of the first agent output, receiving by the first agent from the one or more second agents in one or more data streams, individual subsections of one or more second agent outputs generated by the one or more second agents. The operations can include during decoding of the first agent output, dynamically updating, by the first agent, a decoding trajectory of the first agent output based on the received individual subsections of the one or more second agent outputs.

In some implementations, dynamically updating, by the first agent, the decoding trajectory of the first agent output includes generating an additional sequence of multiple first agent output data elements.

In some implementations, the operations include, during decoding of the first agent output, streaming, by the first agent, individual elements of the sequence of multiple first agent output data elements to the one or more second agents as they are generated.

Other example aspects of the present disclosure are directed to other systems, methods, apparatuses, tangible non-transitory computer-readable media, and devices for performing functions described herein.

These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

For instance, aspects of the present disclosure can provide for a number of technical effects and benefits such as reducing the computational resources of machine-learned models, improving the information quality available to users, and efficiently decoding diverse outputs of machine-learned models in a single call as further described herein.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a block diagram of an example computing system according to example embodiments of the present disclosure;

FIG. 3 depicts a block diagram of an example dataflow pipeline according to example embodiments of the present disclosure;

FIG. 4 depicts a block diagram of an example dataflow pipeline according to example embodiments of the present disclosure;

FIG. 5 depicts a flow chart diagram of an example method to generate efficient communications according to example embodiments of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for improved asynchronous communication between multiple artificial intelligence agents (“agents”) which each comprise one or more machine-learned models. More particularly, one challenge existing in the field of machine learning is that during multi-agent communications between multiple agents (e.g., multi-modal agents), the agents typically start the communication by sharing general context before separately generating and responding to messages among each other, potentially over multiple “turns”. For example, a first agent may communicate with a second agent and a third agent to complete a task for a user. The discussion may begin by sharing context associated with the task and the first agent, the second agent, and the third agent may exchange a series of communications until the agents obtain a desired result or otherwise complete the assigned task.

However, these communications may include inefficiencies that increase consumption of computing resources. For instance, each agent can send a message to the other agents and the message may be integrated into the context of the other agents when they engage in the discussion. As more messages are exchanged or more agents are engaged in the multi-agent communication session, the context for each agent may proportionately grow in size (e.g., in terms of number of bits required to store the context). The agents may utilize information contained in messages received from other agents when predicting tokens to decode into a response to the message. The growth in context size may increase consumption of computing resources for the agents to make inferences. This is particularly true for models which perform self-attention operations, which scale quadratically with context size.

Accordingly, as more agents engage in the communication, the growth size of the context may cause agents to take longer and utilize additional computing resources to generate a message. Moreover, agents in a multi-agent communication will have to wait increasingly longer to receive a response which in turn increases latency of the communications over time. Thus, a technical problem in the field of machine learning is how to facilitate communications between multiple agents while preserving computing resources and minimizing latency.

In view of the above challenge, the systems and methods described herein can provide for improved multi-agent communications by enabling multiple agents to engage in asynchronous communications. In particular, in some examples, a first agent engaging in a multi-agent communication session can access a current set of context data elements associated with the multi-agent communication session. The set of context data elements can include a context window which includes textual data and/or other data modalities that an agent can consider while generating a message. The first agent can generate a first output data element associated with a first agent output. The output data element can include one or more tokens or sequences of tokens included in an agent output (e.g., message). For instance, the first agent output may include first output data elements that are decoded over a plurality of decoding iterations which are based on the current set of context data elements.

Before completion of the first agent output, the first agent may receive one or more output data streams from other agents participating in the multi-agent communication session. The output data stream may include second agent output data elements (e.g., tokens, sequences of tokens, etc.) of one or more second agent outputs generated by the other agents. By way of example, a second agent participating in the multi-agent communication session may also generate agent outputs (e.g., second agent outputs) in response to the first agent output from the first agent or other agent outputs from one or more other agents. After receiving the data streams, the first agent (e.g. or other agents) can update the current set of context data elements.

In an embodiment, updating the current set of context data elements can include inserting the second agent output data elements into the current set of context data elements. For instance, the second agent output data elements may be inserted in a sequence according to a time of receipt of the second agent output data elements. In this manner, the first agent may consider or prioritize the most recent output data elements (e.g., tokens, sequences of tokens, etc.) that are being decoded by the second agent or other agents participating in the multi-agent communication session.

In an embodiment, updating the current set of context data elements can include interleaving the second agent output data elements with the one or more first agent output data elements. Interleaving output data elements may include pausing or withholding tokens or sequences of tokens from the second agent or other agents. For instance, one or more agents participating in the multi-agent communication session may not continuously generate messages. An example of an agent pausing the generation of a message may include agents which are awaiting a response, have completed a response, or otherwise do not have context to add to the discussion. By interleaving output data elements when agents are not generating messages, agents may avoid increasing the size of context associated with other agents participating in the multi-agent communication session. In this manner, the agents may engage in asynchronous communications more efficiently while preserving computing resources.

Before completion of the first agent output, the current set of context data elements may be updated based on the data streams from the second agent or other agents. For example, as the first agent is decoding the first agent output, the current set of context data elements can be updated to allow the first agent to consider what the second agent or other agents are also decoding asynchronously. In an embodiment, the current set of context data elements may be updated at each decoding step. In this manner, the context growth for a response may be restricted allowing the first agent to consider the most recently provided information at each decoding step.

Based on the updated current set of context data, the first agent may generate additional first agent output data elements to include in the first agent output. In an embodiment, the first agent may dynamically update a decoding trajectory of the first agent output. For instance, information decoded by other agents participating in the multi-agent communication session may cause the first agent to dynamically adjust the tokens decoded into a message.

In some embodiments, the first agent may also generate a data stream which may be received by other agents and used to update context data elements associated with the other agents. For instance, the first agent may initiate decoding of a first agent output and generate a sequence of multiple first agent output data elements (e.g., token sequences, etc.). While the first agent is decoding the first agent output, each of the first agent output data elements of the sequence of first agent output data elements may be streamed to the other agents. In this manner, the first agent and the other agents may engage in asynchronous communications without increasing latency due to waiting for other agents to finish decoding messages before another agent may respond.

Example aspects of the present disclosure provide systems and methods for improved asynchronous communications between multiple machine-learned models. For instance, the systems and methods described herein enable agents to optimize asynchronous communications with other agents in real time by streaming tokens as they are decoded to other agents allowing the other agents to more quickly obtain context and decode or update a decoding trajectory of a response, thereby reducing computational costs and latency associated with multi-agent collaboration. For example, aspects of the present disclosure can provide a set of agents that can each update context data based on the most recent tokens decoded by other agents and generate a response. This enables agents within a multi-agent communication session to more quickly reach a desired result or complete a task. Furthermore, agents may avoid wasting computing resources resulting from expensive inferences due to large context that grows over the course of a communication session.

Example aspects of the present disclosure can provide for a number of technical effects and benefits, including improvements to computing technology. As one example, enabling agents to communicate asynchronously can improve communication for machine-learned models. For instance, agents can more readily solve problems collaboratively by accessing intermediate messages from other agents.

By way of example, multiple agents engaged in a multi-agent communication session for collaborative software generation may generate complex reasoning traces to explain their software generation preferences and/or decisions in a synchronous mode and generate complex reasoning traces to explain their software generation preferences. However, in an asynchronous mode, an agent may determine another alternative way to generate the same code (e.g., function, code snippet, etc.), based on a data stream from another agent including an intermediate message (e.g., agent output data elements) that indicates an alternative or opposition to particular piece of code. This provides an alternative perspective and additional context to each of the models in real-time as messages are being decoded. In this manner, agents in a multi-agent system may generate increasingly faster and accurate forms of early exits while still giving each an ability to determine alternatives or end a discussion.

With reference now to the Figures, example embodiments of the present disclosure will be discussed in further detail.

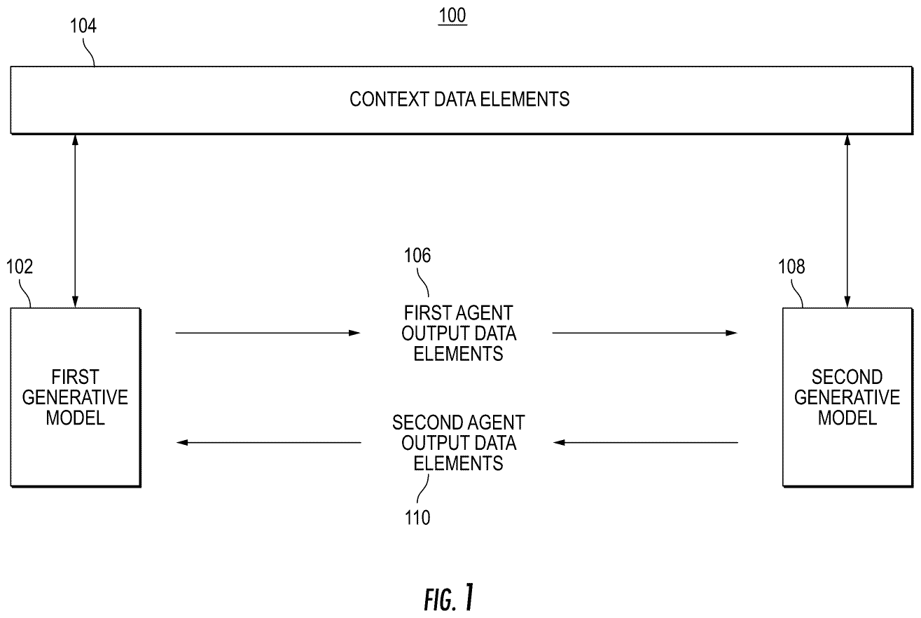

FIG. 1 depicts a block diagram of an example computing system 100 according to example embodiments of the present disclosure. In some implementations, the computing system 100 is configured to facilitate asynchronous multi-agent communications between a first generative model 102 and a second generative model 108 based on context data elements 104 which may be iteratively updated as the first generative model 102 and the second generative model 108 exchange first agent output data elements 106 and second output data elements 110 respectively. The context data elements 104 can include a general or a shared context associated with the multi-agent communications between the first generative model 102 and the second generative model 108.

For instance, the context data elements 104 may be associated with a context window (e.g., context length). A context window may be an amount of text (e.g., in tokens) that a machine-learned model can consider at a point in time. For example, the first generative model 102 and the second generative model 108 may utilize the context data elements 104 within a context window to generate output data (e.g., output data elements). In an embodiment, the context data elements 104 within a context window (e.g., for each decoding step) may be iteratively updated at each decoding step as the first generative model 102 and the second generative model 108 generate output data elements to provide the most recent (e.g., or relevant) context as the next token is decoded. In this manner, the technology of the present disclosure may alleviate technical issues resulting from increased context growth over the course of an asynchronous multi-agent communication.

By way of example, as the multi-agent communication is initialized, the first generative model 102 and the second generative model 108 may contribute information to the context data elements 104 such as an initial user instruction (e.g., prompt from a user) which forms the basis of the multi-agent communication, task-specific data (e.g., data associated with the initial user instruction, etc.), user specific data (e.g., preferences, etc. associated with the prompting user), a list of generative models (e.g., agents) participating in the multi-agent communication, etc.. In an embodiment, the information shared upon initialization of the multi-agent communication may be contained with a context window to enable the first generative model 102 and the second generative model 108 to begin generating output data elements with shared or general context.

The first generative model 102 and the second generative model 108 can be any suitable model. For example, in some implementations, the first generative model 102 and the second generative model 108 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner.

In an embodiment, the computing system 100 may be an agent system. An agent system (e.g., an “artificial intelligence agent” or “AI agent”) can employ one or more machine-learned models (e.g., generative models, etc.) to generate outputs responsive to queries from users. As one example, an agent system can be or can include a computing system including one or more machine-learned token generation models, where the computing system is configured to receive an input from a user device or calling device and provide an output including a plurality of tokens that are responsive to the input to the user device or calling device. As one example, the plurality of tokens can be or can include text data such as words, and/or the plurality of tokens can collectively form a passage or block of text that is displayed to the user. The plurality of tokens can, for instance, collectively describe an answer or response to the user's input.

Furthermore, in some implementations, the plurality of tokens can be or can include (e.g. or can be converted to) spoken language data such as audio data that can be spoken to the user. In some implementations, the generative models can output values, such as confidence scores or certainty scores, tonality scores, and/or other suitable scores and/or values, which are respectively associated with the plurality of tokens.

In some implementations, the agent system can be or can implement a multi-modal agent (e.g., a multi-modal artificial intelligence agent). For instance, a multi-modal agent can process inputs from one or more data modalities. In some implementations, the agent system can be implemented as a “situated agent”. For example, the first generative model 102 or the second generative model 108 may be “situated agents” which generate first agent output data elements 106 and second output data elements 110 respectively by communicating asynchronously to generate a response or complete a task for users.

The first generative model 102 and the second generative model 108 may build upon or otherwise update the general context (e.g., context data elements 104) with information received from exchanging outputs (e.g., prompts, responses, natural language texts, etc.) asynchronously. The outputs can include output data elements (e.g., first agent output data elements 106, second output data elements 110, etc.) that are provided to all generative models participating in the multi-agent communication asynchronously. For instance, the first generative model 102 and the second generative model 108 may generate respective data streams (e.g., including the output data elements) which provide the other generative models participating in the multi-agent communication with output data elements as they are decoded asynchronously by each generative model.

The first agent output data elements 106 and the second output data elements 110 can include one or more tokens or sequences of tokens sampled by the first generative model 102 or second generative model 108 respectively. For instance, the first agent output data elements 106 and the second output data elements 110 may be words, phrases, or intermediate messages. A token can be a portion of a larger response or answer (e.g., agent output, etc.) produced by the first generative model 102 or the second generative model 108. The token can be any suitable token, such as, for example, a text token including text data, such as a word, phrase, sentence, letter, or other suitable delineation of text. For example, the first agent output data elements 106 and the second output data elements 110 may be included in an output (e.g., first agent output, second agent output, etc.) based on the context data elements 104.

By way of example, the first generative model 102 and the second generative model 108 may be participating in a multi-agent communication to generate software for a user. For instance, the first generative model 102 may be a “situated agent” of a user and initiate a multi-agent communication with a second generative model 108 which may be a specialized source code generation agent. The first generative model 102 and the second generative model 108 may generate context data elements 104 by sharing context such as requirements for the software, user functionality, configuration values, etc. The first generative model 102 may access the context data elements 104 and proceed to generating a first agent output which includes a sequence of first agent output data elements 106. For example, the first generative model 102 may begin generating a first agent output (e.g., prompt) requesting a code snippet for integrating email functionality into a particular software application from the second generative model 108.

Before completion of the first agent output, the first generative model 102 may receive from the second generative model 108, a data stream including second output data elements 110. For instance, the first generative model 102 may also stream the first agent output data elements 106 (e.g., included in the first agent output) to the second generative model 108 as respective output data elements of the first agent output data elements 106 are being decoded. In this manner, the first generative model 102 and the second generative model 108 may asynchronously communicate intermediate portions (e.g., output data elements) of output data as the output data is being generated.

Output data elements received by a generative model may be used to update the context data elements 104. For example, the first generative model 102 may receive the data stream including the second output data elements 110 and update the context data elements 104 to include the second output data elements 110. By way of example, the second generative model 108 may receive the first agent output data elements 106 indicating that that first generative model 102 is in the process of generating a prompt to request a code snippet for email functionality. For instance, a sequence of first agent output data elements 106 may include an intermediate message such as “provide code snippet for email functionality”.

Based on the second generative model 108 receiving a data stream including the intermediate message “provide code snippet for email functionality”, the second generative model 108 may access context data elements 104 indicating that the application is hosted on a cloud platform and begin generating second output data elements 110. For instance, a sequence of second output data elements 110 may include an intermediate message “provide cloud SMTP server” prompting the first generative model 102 to define a cloud email SMTP server to use for configuring the email code snippet. The first generative model 102 may receive the second output data elements 110 (e.g., intermediate message) indicating that an SMTP server needs to be defined and update the context data elements 104 to include the specific SMTP server as additional context for the multi-agent communication. For instance, the context data elements 104 may be updated to include tokens associated with a particular electronic mail SMTP server that may be considered by the first generative model 102 as the first agent output is being decoded. In this manner, a decoding trajectory of the first generative model may be dynamically updated.

For instance, by considering the updated context data elements 104 (e.g., within a context window) indicating the electronic mail server, the first generative model 102 may generate one or more additional first agent output data elements 106 of the first agent output to include at least an identifier associated with a particular electronic mail service or server within the first agent output. The additional first agent output data elements 106 may allow the first generative model 102 to more efficiently prompt the second generative model 108 to request generation of email source code and reduce latency.

For example, the first generative model 102 may avoid fully decoding messages which result in a follow up or clarifying response based on asynchronously communicating output data elements (e.g., intermediate messages) as they are decoded and considering updated context data elements 104 at each decoding step. Moreover, the first generative model 102 may reduce latency by avoiding additional wait times for the second generative model 108 to fully decode a responsive message which merely requests additional information or clarification. For instance, the first generative model 102 may decode additional first agent output data elements 106 such as “for electronic mail service” subsequent to the intermediate message “provide code snippet for email functionality” (e.g., “provide code snippet for email functionality for electronic mail service”) to provide clarity and avoid follow-up questions, wait times, etc.

The first generative model 102 and the second generative model 108 may iteratively decode, stream, and receive output data elements and consider updated context data elements 104 at each decoding step. In an embodiment, before completion of an output, the generative models may update an associated key-value (KV) cache based on the output data. elements. A KV cache may include a key-value store of entity keys and their descriptions for each generative model which enable the generative models to embed the outputs (e.g., first agent outputs, second agent outputs, etc.) in the agent context.

For example, the KV cache may enable the generative models to parse entities out of inputs and validate the logical consistency of all statements about entities at each decoding step and throughout the asynchronous multi-agent communication. The generative models may update respective KV caches based on the first agent output data elements 106 and the second output elements to store intermediate computations at each decoding step. As an asynchronous multi-agent communication occurs, the KV cache may also expand in size proportionally.

In an embodiment, the first generative model 102 and the second generative model 108 may limit the size of the KV cache according to time stamps (e.g., time of receipt, generation, etc.) associated with the first agent output data elements 106 and the second output data elements 110. For instance, tokens which appear earlier within a conversation transcript may be dropped from the KV cache as the asynchronous multi-agent communication evolves. By way of example the first generative model 102 and the second generative model 108 may limit size of the KV cache by avoiding adding additional context based on the response (e.g., intermediate messages) received from other generative models participating in the asynchronous multi-agent communication.

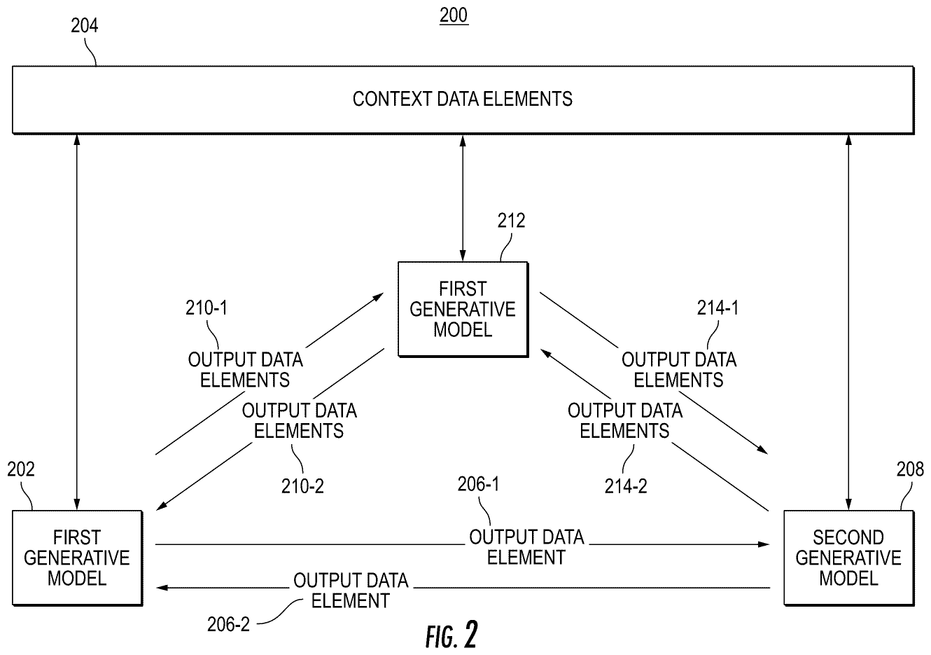

FIG. 2 depicts a block diagram of an example computing system according to example embodiments of the present disclosure. The computing system 200 is similar to the computing system 100 of FIG. 1 except that computing system 200 further includes a third generative model 210.

In particular, the computing system 200 can facilitate asynchronous multi-agent communications by the first generative model 202, the second generative model 206, and/or a third generative model 210. For instance, the first generative model 202, the second generative model 208, and the third generative model 212 may each contribute initial context data elements 204. The initial context data elements 204 may be iteratively updated as the first generative model 202, the second generative model 206, and the third generative model 210 exchange output data elements 210-1, 210-2, 210-3 amongst each other. The context data elements 204 can include a general or a shared context associated with the multi-agent communications between the first generative model 202, the second generative model 208, and the third generative model 212.

While examples herein describe a second generative model 206 and a third generative model 210 participating in an asynchronous multi-agent communication with the first generative model 202, the present disclosure is not limited to such embodiment and any number (e.g., N) of generative models may participate in a multi-agent communication.

The context data elements 204 may be associated with a context window (e.g., context length). A context window may be an amount of text (e.g., in tokens) that a machine-learned model can consider at a point in time. For instance, the first generative model 202, the second generative model 206, and the third generative model 210 may utilize the context data elements 204 within a context window to generate output data (e.g., output data elements). In an embodiment, the context data elements 204 within a context window (e.g., for each decoding step) may be iteratively updated at each decoding step as the first generative model 202, the second generative model 206, and the third generative model 210 generate output data elements 206-1, 206-2, 210-1, 210-2, 214-1, 214-2 to provide the most recent (e.g., or relevant) context as the next token is decoded.

The first generative model 202, the second generative model 206, and the third generative model 210 can be any suitable model. For example, in some implementations, the first generative model 202, the second generative model 206, and the third generative model 210 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner. In an embodiment, the computing system 200 may be an agent system that can employ one or more machine-learned models (e.g., generative models, etc.) to generate outputs responsive to queries from users.

The first generative model 202, the second generative model 206, and the third generative model 210 may each build upon or otherwise update the general context (e.g., context data elements 104) by exchanging outputs (e.g., prompts, responses, natural language texts, etc.) asynchronously. The outputs can include output data elements 206-1, 206-2, 210-1, 210-2, 214-1, 214-2 that are provided to all generative models participating in the multi-agent communication asynchronously. For instance, the first generative model 202, the second generative model 206, and the third generative model 210 may each generate respective data streams (e.g., including the output data elements) which provide the other generative models participating in the multi-agent communication with output data elements as they are decoded asynchronously by each generative model.

The output data elements 206-1, 206-2, 210-1, 210-2, 214-1, 214-2 can include one or more tokens or sequences of tokens sampled by the first generative model 202, second generative model 206, or the third generative model 210 respectively. For instance, the output data elements 206-1, 206-2, 210-1, 210-2, 214-1, 214-2 may be words, phrases, or intermediate messages. The token can be a portion of a larger response or answer (e.g., agent output, etc.) or any suitable token, such as, for example, a text token including text data, such as a word, phrase, sentence, letter, or other suitable delineation of text. For example, the output data elements 206-1, 206-2, 210-1, 210-2, 214-1, 214-2 may be included in an output (e.g., first agent output, second agent output, third agent output, etc.) based on the context data elements 204.

By way of example, the first generative model 202, the second generative model 206, and the third generative model 210 may be participating in a multi-agent communication to schedule a calendar event for one or more users. For instance, the third generative model 210 may be a “situated agent” of a user and initiate a multi-agent communication with the first generative model 202 which may be a specialized location reservation agent and the second generative model 208 which may be an agent associated with third-party vendors. The first generative model 202, the second generative model 206, and the third generative model 210 may generate context data elements 104 by sharing context such as event dates, event location options, third-party vendor services, etc.

The third generative model 210 may access the context data elements 104 and proceed to generating a third agent output which includes a sequence of output data elements (e.g., output data elements, 210-2, 214-2, etc.). For example, the third generative model 210 may begin generating a third agent output (e.g., prompt) to the first generative model 202 and the second generative model 206 requesting collaboration for scheduling an event for fifty people.

In an embodiment, before completion of the third agent output the third generative model 210 may generate a data stream including the output data elements 210-2, 214-2 at each decoding step as the output data elements 210-2, 214-2 are being decoded. The data stream including the output data elements 210-2, 214-2 may be received by the first generative model 202 and the second generative model 208. For instance, the first generative model 202 and the second generative model 208 may each receive via the data stream, an intermediate message (e.g., output data elements 210-2, 214-2) “provide availability for” as an intermediate portion of the third agent output. The intermediate message may indicate to the first generative model 202 and the second generative model 208 that the third generative model 210 is requesting availability from the first generative model 202 (e.g., for locations) and the second generative model 208 (e.g., for third-party vendors).

Based on the output data elements 210-2, 214-2 that are being decoded by the third generative model 210 and before completion of the third agent output, the first generative model 202 and/or the second generative model 208 may update the context data elements 204. For example, the first generative model 202 and/or the second generative model 208 may receive the data stream including the output data elements 210-2, 214-2, etc. and update the context data elements 204 to include the output data elements 210-2, 214-2.

By way of example, based on the first generative model 202 receiving a data stream including the intermediate message “provide availability for”, the first generative model 202 may access the context data elements 204 indicating that the requesting user will need a location large enough for at least 50 people (e.g., “50 guests”) and begin generating output data elements 206-1, 210-1. For instance, a sequence of output data elements 206-1, 210-1 may include an intermediate message “indoor or outdoor” prompting the third generative model 210 to clarify whether there is a preference between indoor or outdoor locations. In an embodiment, the first generative model 202 may stream the output data elements 206-1, 210-1 to the second generative model 208 and the third generative model 212 asynchronously. In embodiment, the second generative model 208 may also stream output data elements 206-2, 214-1 asynchronously.

For instance, before completion of the third agent output, and based on the output data elements 214-2 received from the third generative model 212 and/or based on the output data elements 206-1 received from the first generative model 202, the second generative model 208 may subsequently or concurrently access the context data elements 204 and begin generating output data elements 206-2, 214-1. For example, in one embodiment, the second generative model 208 may access the updated context data elements 204 which include updated context based on the third generative model (e.g., output data elements 210-2, 214-2) indicating the request for availability of a vendor that can provide services for at least 50 people (e.g., “50 guests”) and begin generating output data elements 206-2, 214-1. For example, a sequence of output data elements 206-2, 214-1 may include an intermediate token “cuisine” prompting the third generative model 212 to clarify whether food or refreshments vendors will be needed for the event.

In another embodiment, the second generative model 208 may concurrently or subsequently receive data streams from the third generative model 210 and the first generative model 202. For instance, the second generative model 208 may access the context data elements 204 based on the output data elements from the third generative model 212 and the first generative model 202. In such embodiment, the second generative model 208 may access additional context that also indicates that vendors who provide services for the event will need to be able to provide services for at least 50 people and potentially provide services at an indoor or outdoor location.

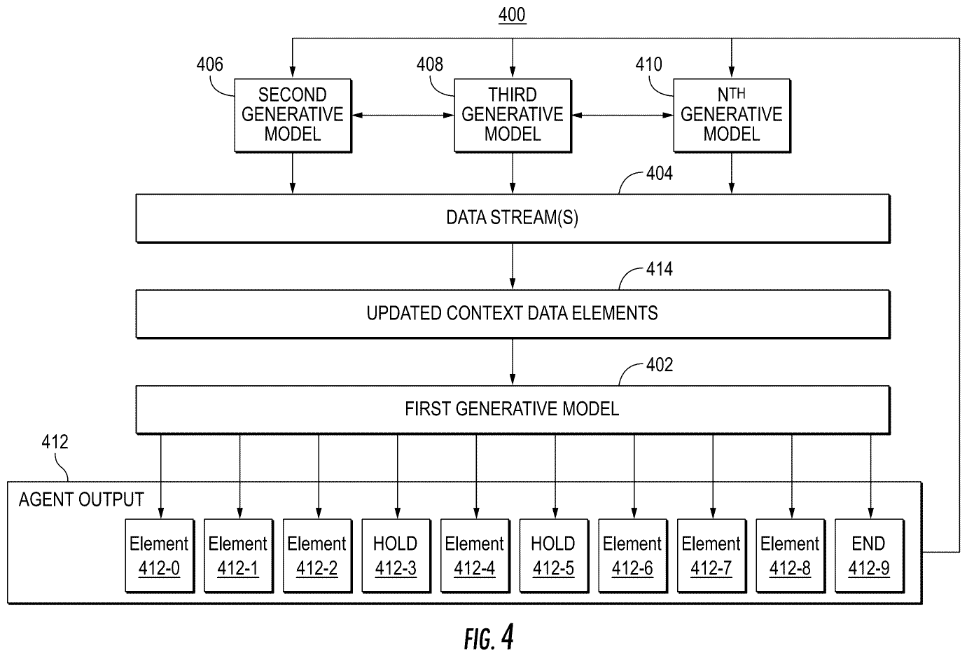

In some embodiments, additional context from multiple data streams may cause the second generative model 208 to wait until the third generative model 212 has provided a clarification on indoor or outdoor locations before responding. For instance, the second generative model 208 may interleave one or more output data elements 206-2, 214-1. Interleaving output data elements may include pausing at a decoding step. A pause or hold at a decoding step may allow other generative models participating in the asynchronous multi-agent communication to decode additional output data elements (e.g., provide additional context). In some embodiments, an interleave may also limit the size of the context growth when a generative model does not have any information to add to the communication. An interleave of output data elements is further described with reference to FIG. 4.

In other embodiments, the second generative model 208 may begin decoding a second agent output including output data elements 206-2, 214-1. For instance, the second generative model 208 may determine that only a few vendors provide outdoor services and begin generating output data elements 206-2, 214-1 “limited outdoor events”. A data stream including the output data elements 206-2, 214-1 may be received by the third generative model 212 and the first generative model 202 which causes the third generative model 212 and/or the first generative model 202 to further update the context data elements 204 to include the additional context.

The additional context may be considered by all generative models asynchronously as each agent iteratively decodes output. For instance, the third generative model 212 may adjust a decoding trajectory of the third agent output based on the additional context associated with the indoor and outdoor options and further adjust the decoding trajectory based on limited vendor availability for outdoor locations. In this manner, the technology of the present disclosure may facility asynchronous multi-agent communications more efficiently.

In an embodiment, the increased number of generative models participating within an asynchronous multi-agent communication may cause in influx of updates to the context data elements 204. For instance, the context may grow proportionally as tens, hundreds, or thousands of generative models participate in asynchronous multi-agent communications. To address this issues, each of the generative models may insert (e.g., update) the output data elements into the current set of context data elements 204 in a sequence according to a time of receipt of the data stream (e.g., including the output data elements) for instance, more recent output data elements may have a higher relevance and provide updated context for the generative models at each decoding step.

By way of example, the third generative model 212 may insert the output data elements 210-1 from the first generative model 202 into the context data elements 204 after the the output data elements 214-1 from the second generative model 208 based on receiving the output data elements 210-1 from the first generative model 202 first. In this manner, the context that limited vendors will be available in outdoor locations may be more relevant to the next token or sequence of tokens (e.g., output data elements) decoded into the third agent output. For instance, the third generative model 212 may generate additional output data elements 210-2, 214-2 such as “indoor event” (e.g., “provide availability for and indoor event”) based on the relevance of whether the event is indoors or outdoors.

Moreover, the additional output data elements 206-1, 214-2 may also enable the second generative model 208 to more quickly resume decoding the second agent output based on receiving additional context regarding the indoor location of the event. The first generative model 202, second generative model 208, and the third generative model 212 may iteratively decode and stream output data elements 206-1, 206-2, 210-1, 210-2, 214-1, 214-2 and update the context data elements 204 at each decoding step until the calendar event has been planned. For instance, the generative models may terminate or otherwise end an asynchronous multi-agent communication by generating a termination data element. A termination data element may indicate an end to a sequence of output data elements 206-1, 206-2, 210-1, 210-2, 214-1, 214-2. An example of termination data elements is further described with reference to FIG. 4.

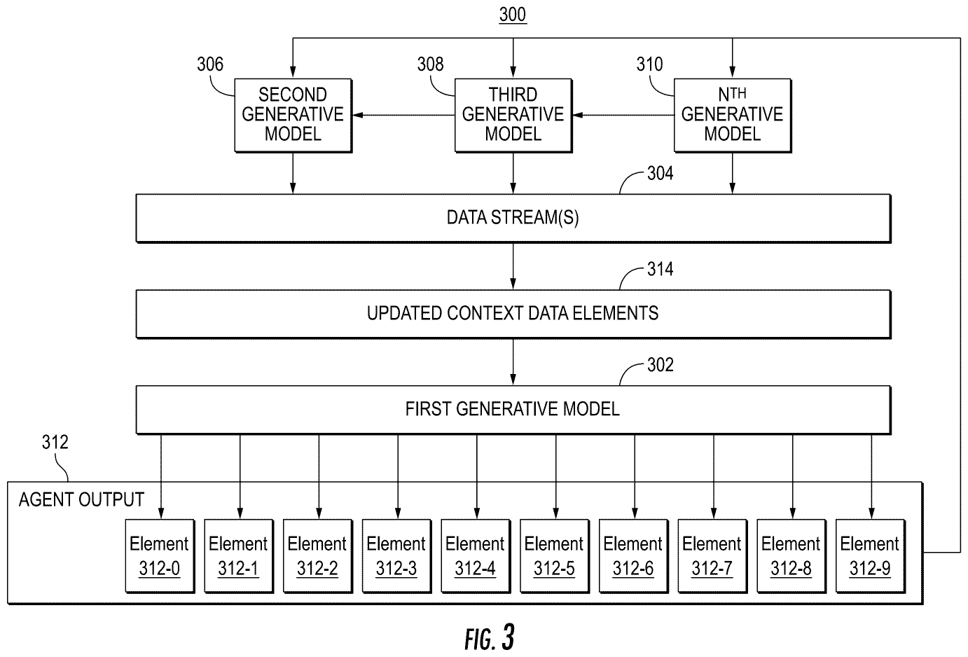

FIG. 3 depicts a block diagram of an example dataflow pipeline according to example embodiments of the present disclosure. Although FIG. 3 depicts steps performed in a particular order for purposes of illustration and discussion, the methods of the present disclosure are not limited to the particularly illustrated order or arrangement. The various steps of dataflow pipeline 300 can be omitted, rearranged, combined, and/or adapted in various ways without deviating from the scope of the present disclosure.

In particular, dataflow pipeline is described with an example implementation in which a first generative model 302 participating in an asynchronous multi-agent communication with a second generative model 306, a third generative model 308, and/or a N generative models 310 generates a first agent output 312 that includes output data elements 312-0, . . . , 312-9 decoded over a plurality of decoding iterations. Before completion of the first agent output 312, the first generative model 302 may stream the output data elements 312-0, . . . , 312-9 at each decoding step to the second generative model 306, the third generative model 308, and/or the N generative models 310. N generative models 310 can include any number of generative models that are participating in the asynchronous multi-agent communication. In response to receiving the output data elements 312-0, . . . , 312-9, the second generative model 306, the third generative model 308, and/or the N generative models 310 may also begin generating agent respective agent outputs and generate one or more data streams 304 to each other and the first generative model 302. For instance, the respective agent outputs may each contain agent output data elements as they are decoded by the respective agent generative model.

The first generative model 302, the second generative model 306, and the N generative models 310 can be any suitable model. For example, in some implementations, the first generative model 302, the second generative model 306, and the N generative models 310 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner. In an embodiment, the dataflow pipeline may be implemented by an agent system that can employ one or more machine-learned models (e.g., generative models, etc.) to generate outputs responsive to queries from users.

The one or more data streams 304 may include a transmission of a sequence of digitally encoded signals to convey information. For instance, the one or more data streams 304 may include agent output data elements (e.g., tokens, sequences of tokens, etc.) that convey intermediate or portions of a particular agents'output such as a natural language prompt or response as it is being generated. In an embodiment, the one or more data streams 304 may be transmitted to all generative models participating in the multi-agent communication asynchronously.

In another embodiment, the one or more data streams 304 may be transmitted to a subset of generative models participating in the asynchronous multi-agent communication. For instance, a subset or group of generative models may be associated with a particular subtask and another subset or group of generative models may be associated with another subtask. In an embodiment, a generative model may asynchronously communicate with various groups or subsets of all generative models participating in the asynchronous multi-agent communication. In this manner, nested asynchronous multi-agent communication may be facilitated by various groups or subsets of all generative models participating in a broader asynchronous multi-agent communication.

The one or more data streams 304 may be used to generate updated context data elements 314. For instance, the first generative model 302 may receive the one or more data streams 304 and insert the agent output data elements into a current set of context data element. By way of example, up initializing the asynchronous multi-agent communication, each of the participating generative models may contribute to a shared or general context (e.g., current set of context data elements). Upon generating messages and streaming agent output data elements, output data elements 312-0, . . . , 312-9, etc., the current set of context data elements may be updated to include additional context.

In an embodiment, the first generative model 302 may generate updated context data elements 314 by inserting the agent output data elements from the one or more data streams 304 into the current set of context data elements in a sequence according to a time of receipt of the agent output data elements. For instance, the one or more data streams 304 may be received as each of the second generative model 306, third generative model 308, N generative models decodes agent output data elements. In this manner, the first generative model 302 may receive multiple data streams 304 concurrently or consecutively.

Since all generative models participating in the asynchronous multi-agent communication are also receiving the same data streams, the updated context data elements 314 may be generated by inserting the agent output data elements in the current set of context data elements in sequential order based on a time stamp associated with receipt. In an embodiment, inserting the received agent output data elements sequentially allows the first generative model 302 and/or other generative models to update the context (e.g., context window) with the most recent (e.g., or relevant) context. Moreover, the sequential order may also enable the first generative model 302 and/or other generative models to more easily access historical context (e.g., outside of the context window) of the asynchronous multi-agent communication.

Based on the updated context data elements, 310, the first generative model 302 may continue generating the first agent output 312 by iteratively decoding additional output data elements 312-0, . . . , 312-9 and streaming the output data elements 312-0, . . . , 312-9, to each of the generative models participating in the asynchronous multi-agent communication.

FIG. 4 depicts an example dataflow pipeline 400 according to embodiments of the present disclosure. Although FIG. 4 depicts steps performed in a particular order for purposes of illustration and discussion, the methods of the present disclosure are not limited to the particularly illustrated order or arrangement. The various steps of dataflow pipeline 400 can be omitted, rearranged, combined, and/or adapted in various ways without deviating from the scope of the present disclosure.

In particular, dataflow pipeline is described with an example implementations in which a first generative model 402 participating in an asynchronous multi-agent communication with a second generative model 406, a third generative model 408, and/or a N generative models 410 generates a first agent output 412 that includes output data elements 412-0, . . . , 412-9 decoded over a plurality of decoding iterations. Before completion of the first agent output 412, the first generative model 402 may stream the output data elements 412-0, . . . , 412-9 at each decoding step to the second generative model 406, the third generative model 408, and/or the N generative models 410. N generative models 410 can include any number of generative models which are participating in the asynchronous multi-agent communication.

The first generative model 402, the second generative model 406, and the N generative models 410 can be any suitable model. For example, in some implementations, the first generative model 402, the second generative model 406, and the N generative models 410 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner. In an embodiment, the dataflow pipeline may be implemented by an agent system that can employ one or more machine-learned models (e.g., generative models, etc.) to generate outputs responsive to queries from users.

In an embodiment, before completion of the first agent output 412, the first generative model 402 may interleave one or more output data elements 412-0, . . . , 412-9. Interleaving one or more output data elements 412-0, . . . , 412-9 may include pausing at a decoding step or otherwise withholding a next token within an agent output (e.g., first agent output 412. For instance, the first generative model 402 may, based on the updated context data elements, iteratively decode output data element 412-0, output data element 412-1, and output data element 412-2 before interleaving (e.g., pausing, skipping, etc.) a next token. For instance, output data element 412-3 may be a “pause” or “hold” token which indicates (e.g., via a first agent data stream) that the first generative model 402 is still participating in the asynchronous multi-agent communication but is not decoding any tokens at a particular decoding step.

For example, the first generative model 402 may, at a decoding step determine that additional context may be helpful before decoding a next output data element 412-0, . . . , 412-9 and pause by generating output data element 412-3 to allow another generative model participating in the asynchronous multi-agent communication to provide such context. In an embodiment, the first generative model 402 may, at a decoding step, determine the context window is reaching a maximum length and pause by generating output data element 412-5 to avoid adding additional context (e.g., generating updated context data elements 414).

For instance, interleaving one or more output data element 412-0, . . . , 412-9 may indicate to other generative models that the transmitting generative model is still participating in the participating in the asynchronous multi-agent communication, but does not have anything to contribute to the communication. In this manner, interleaving output data elements (e.g., 412-3, 412-5) may not cause updated context data elements 414 to be generated enabling the generative models to decode agent outputs (e.g., first agent output 412, etc.) more efficiently with concise context.

Additionally and/or alternatively other generative models participating in the asynchronous multi-agent communication may interleave agent output data elements with respective agent output data elements the corresponding agent output. For instance, each of the generative models may concurrently and/or sequentially interleave (e.g., omit, ignore, etc.) interleaving output data elements (e.g., 412-3, 412-5) that are received via the one or more data streams 404. For example, the interleaving output data elements (e.g., 412-3, 412-5) may not convey information (e.g., tokens, sequences, of tokens, etc.) and thus, may not be added to corresponding agent outputs preserving computing resources otherwise expended parsing output data elements unnecessarily.

In an embodiment, interleaving an agent output data element may indicate that the agent output is still in progress and not complete. For instance, the first generative model 402 may interleave agent output data element 412-3, decode output data element 412-4, and interleave agent output data element 412-5, before subsequently decoding the remainder of the output data elements 412-6, . . . , 412-9 of the first agent output 412. In this manner, the first agent may interleave output data elements 412-0, . . . , 412-9 as needed as the first agent output is being decoded.

In an embodiment, the first generative model 402 may group one or more agent output data elements (e.g., received via the one or more data streams 404) based on an originating generative model. For example, as the number of generative models participating in the asynchronous multi-agent communication increases, the first generative model 402 may receive a plurality of data streams 404 from each of the generative models concurrently as each may decode respective agent outputs elements and generate data streams 404 at various rates. In order to consider the context associated with each of the data streams 404, the receiving generative model may group the agent output data elements based on the generative model which decoded the respective agent outputs elements. In this manner, the receiving generative model may also differentiate updated context data elements 414 based on where the agent outputs elements originated (e.g. specialized agent, subset multi-agent communications, etc.)

As the first generative model 402 proceeds to decode the first agent output 412, the first generative model 402 may complete the first agent output 412 by generating a termination output data 412-9. A termination output data element may indicate an end of a sequence of the first agent output 412 as opposed to interleaving or pausing the first agent output 412. The termination output data element may indicate to other generative models participating in the asynchronous multi-agent communication that the transmitting generative model has completed a response, message, etc. In an embodiment, the termination output data element may indicate that the transmitting generative model has nothing additional to contribute to the asynchronous multi-agent communication and is exiting the asynchronous multi-agent communication.

For example, the first generative model 402 may generate output data element 412-9 (e.g., termination output data element) indicating the end of the first agent out 412. The output data element 412-9 may be transmitted via a data stream to the second generative model 406, third generative model 408, and/or N generative models 410 indicating the end of the first agent output 412. In an embodiment, the asynchronous multi-agent communication may terminate once all generative models participating in the asynchronous multi-agent communication have generated termination output data elements. For instance, where no generative model has provided additional output data elements (e.g., via a data stream 404) for a threshold period of time, the asynchronous multi-agent communication may also be terminated.

While examples herein describe termination output data elements as a signal ending the sequence of output data elements 412-0, . . . , 412-9 or the asynchronous multi-agent communication. The present disclosure is not limited to such embodiment, and a termination output data element may also be a token or sequence of tokens which concludes a statement including, but not limited to departing words or phrases, punctions, etc. Additionally, and/or alternatively, termination output data elements may also be excluded from being inserted into the context data elements. For instance, the termination output data elements may not convey relevant information (e.g., tokens, sequences, of tokens, etc.) to the task or communication and thus, may not be added to corresponding agent outputs preserving computing resources otherwise expended parsing output data elements unnecessarily.

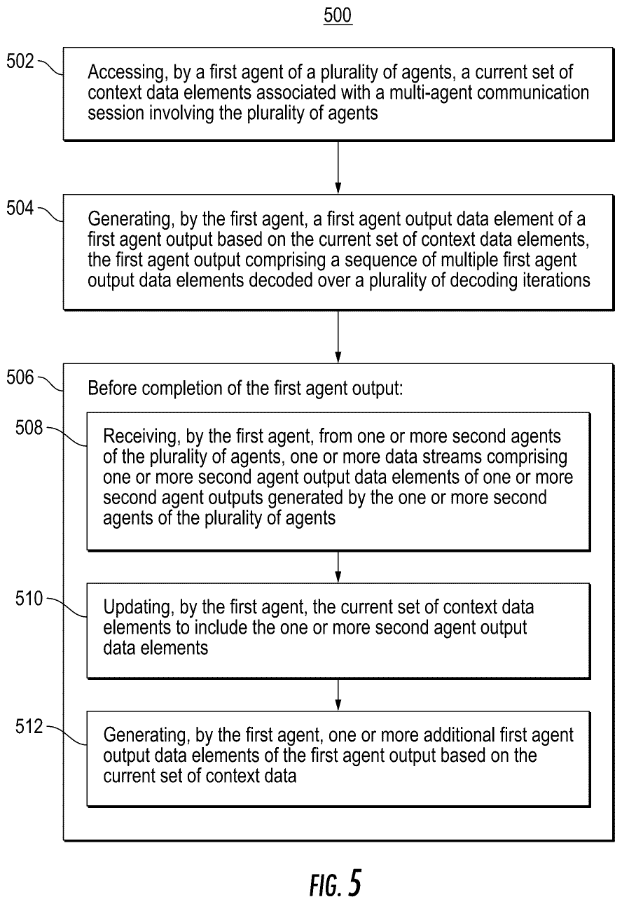

FIG. 5 depicts a flow chart diagram of an example method to generate efficient communications according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can access, by a first agent of a plurality of agents, a current set of context data elements associated with a multi-agent communication session involving the plurality of agents. For example, as the multi-agent communication is initialized, a first generative model and a second generative model may contribute information to a set of initial context data elements such as an initial user instruction (e.g., prompt from a user) which forms the basis of the multi-agent communication, task-specific data (e.g., data associated with the initial user instruction, etc.), user specific data (e.g., preferences, etc. associated with the prompting user), a list of generative models (e.g., agents) participating in the multi-agent communication, etc.. In an embodiment, the information shared upon initialization of the multi-agent communication may be contained with a context window to enable the first generative model and the second generative model to begin generating output data elements with shared or general context.

At 504, the computing system can generate, by the first agent, a first agent output data element of a first agent output based on the current set of context data elements, the first agent output comprising a sequence of multiple first agent output data elements decoded over a plurality of decoding iterations. For example, the first generative model may build upon or otherwise update the general context (e.g., context data elements) with information received from exchanging outputs (e.g., prompts, responses, natural language texts, etc.) asynchronously with the second generative model. The outputs can include output data elements (e.g., first output data elements, etc.) that are provided to all generative models participating in the multi-agent communication asynchronously. For instance, the first generative model may generate a data stream (e.g., including the first agent output data elements) which provide the other generative models participating in the multi-agent communication with output data elements as they are decoded at each decoding step asynchronously by each generative model.

The first output data elements can include one or more tokens or sequences of tokens sampled by the first generative model. For instance, the first output data elements may be words, phrases, or intermediate messages. A token can be a portion of a larger response or answer (e.g., agent output, etc.) produced over a plurality of decoding iterations by the first generative model. The token can be any suitable token, such as, for example, a text token including text data, such as a word, phrase, sentence, letter, or other suitable delineation of text. For example, the first output data elements may be included in an output (e.g., first agent output) based on the context data elements.

At 506, the computing system can, before completion of the first agent output: at 508 receive, by the first agent, from one or more second agents of the plurality of agents, one or more data streams comprising one or more second agent output data elements of one or more second agent outputs generated by the one or more second agents of the plurality of agents. For example, before completion of the first agent output, the first generative model may receive from the second generative model, a data stream including second output data elements. For instance, the first generative model may also stream the first output data elements (e.g., included in the first agent output) to the second generative model as respective output data elements of the first output data elements are being decoded. In this manner, the first generative model and the second generative model may asynchronously communicate intermediate portions (e.g., output data elements) of output data as the output data is being generated.

At 506, the computing system can, before completion of the first agent output: at 510 update, by the first agent, the current set of context data elements to include the one or more second agent output data elements. For example, output data elements received by a generative model may be used to update the context data elements. For instance, the first generative model may receive the data stream including the second output data elements and update the context data elements to include the second output data elements.

In an embodiment, the first generative model may receive the second output data elements (e.g., intermediate message) and update the context data elements by inserting the second output data elements into the current set of context data element to include the additional context for first generative model or other generative models participating in the multi-agent communication to consider at each decoding iteration. For instance, the context data elements may be updated to include tokens that may be considered by the first generative model as the first agent output is being decoded. In this manner, a decoding trajectory of the first generative model may also be dynamically updated.

At 506, the computing system can, before completion of the first agent output: at 512 generate, by the first agent, one or more additional first agent output data elements of the first agent output based on the current set of context data elements. For example, by considering the updated context data elements (e.g., within a context window), the first generative model may generate one or more additional first agent output data elements of the first agent output to include within the first agent output.

For example, the first generative model may avoid fully decoding messages which result in a follow up or clarifying response based on asynchronously communicating output data elements (e.g., intermediate messages) as they are decoded and considering updated context data elements at each decoding step. Moreover, the first generative model may reduce latency by avoiding additional wait times for the second generative model to fully decode a responsive message which merely requests additional information or clarification.

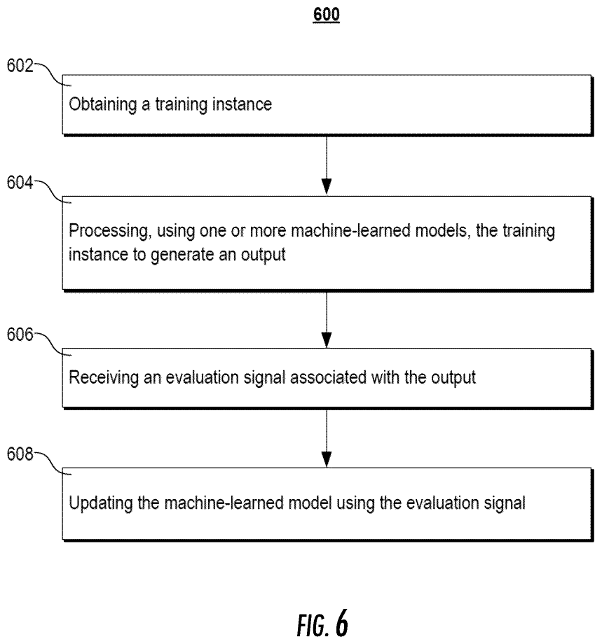

FIG. 6 depicts a flowchart of a method 600 for training one or more machine-learned models according to aspects of the present disclosure. For instance, an example machine-learned model can include a decoder model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

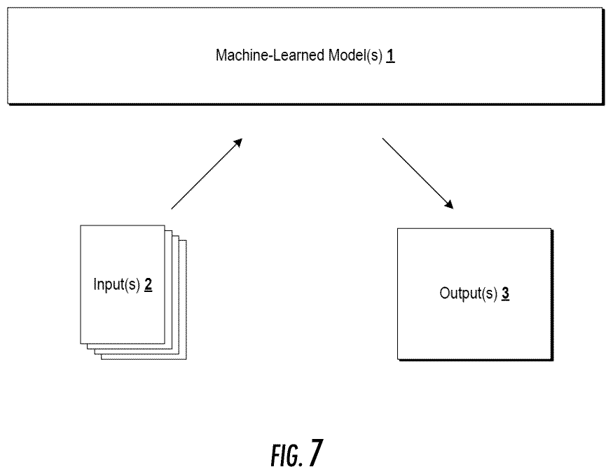

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include or otherwise be representative of any one or more of the machine-learned models described above with respect to the preceding figures. For example, machine-learned model(s) 1 can be or include, or otherwise be representative of any one or more of decoder models, etc. Although various features, variations, and implementations described below are described with respect to machine-learned model(s) 1, it is to be understood that such features, variations, and implementations are to be understood as described with respect to each of decoder models, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a sub the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

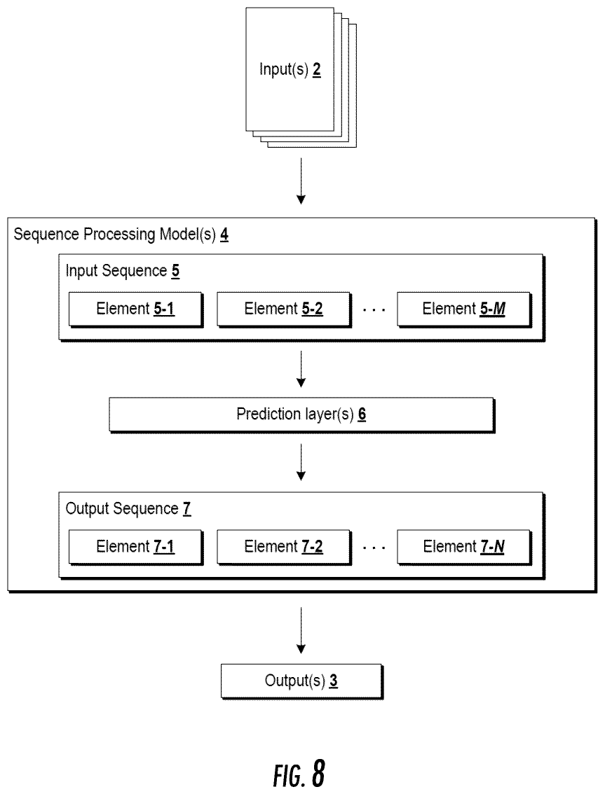

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., AudioLM: a Language Modeling Approach to Audio Generation, arXiv: 2209.03143v2 (Jul. 26, 2023),

, biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a classes into which an input sequence is to be classified. For instance, a vision transformer block can pass latent state information to a multilayer perceptron that outputs a likely class value associated with an input image.

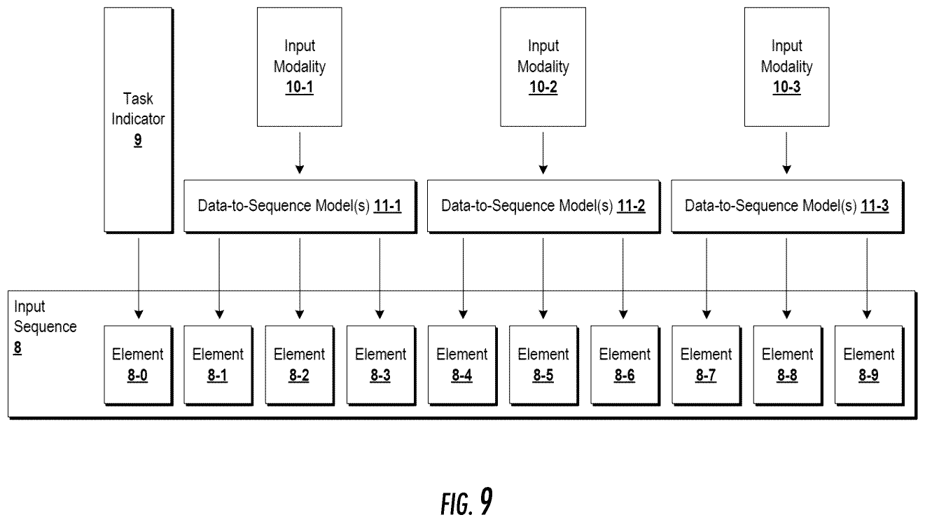

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

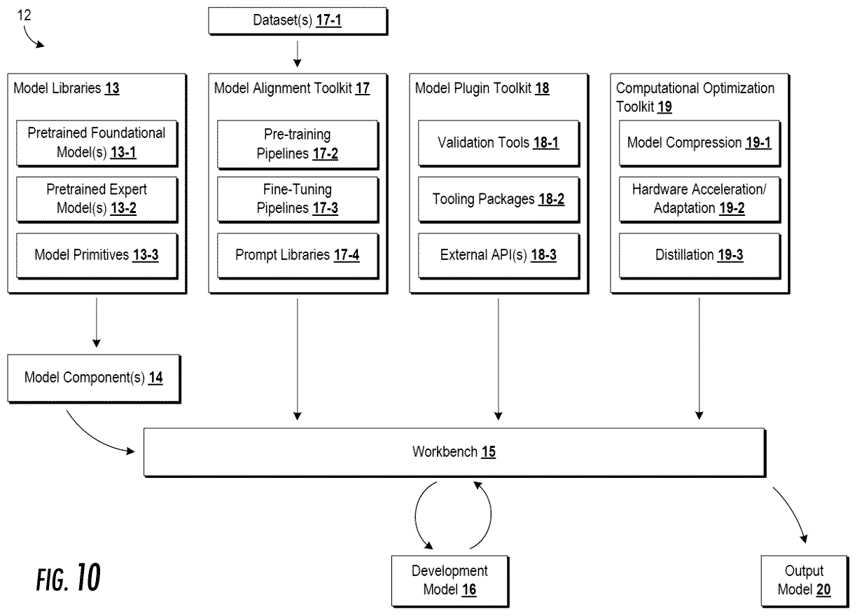

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

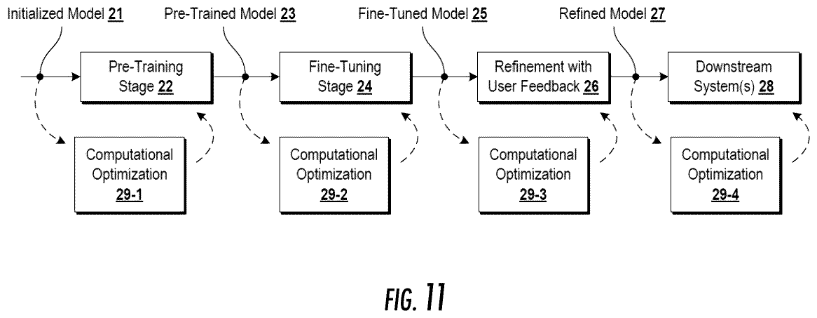

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

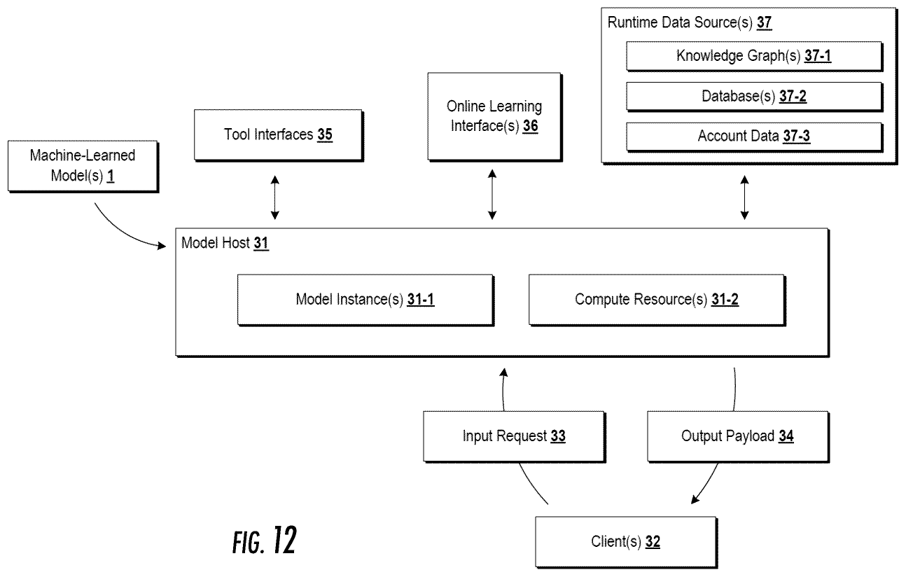

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined categories. For example, the categories can be foreground and background. As another example, the categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

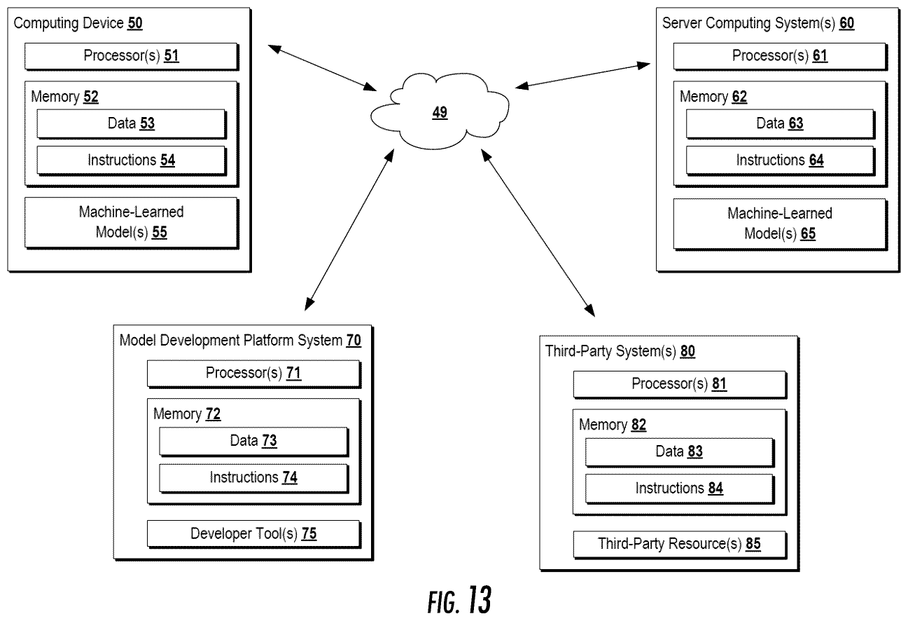

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

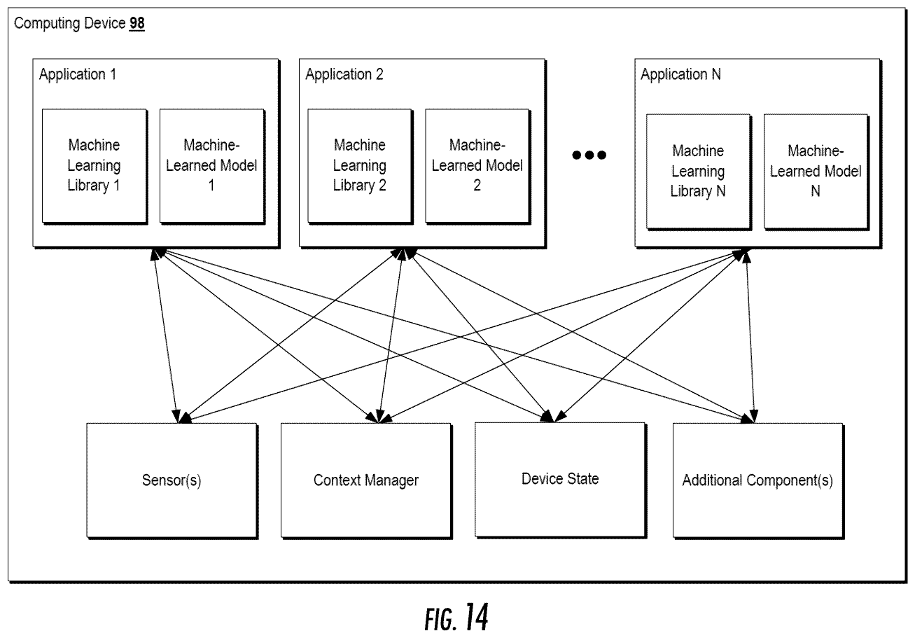

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

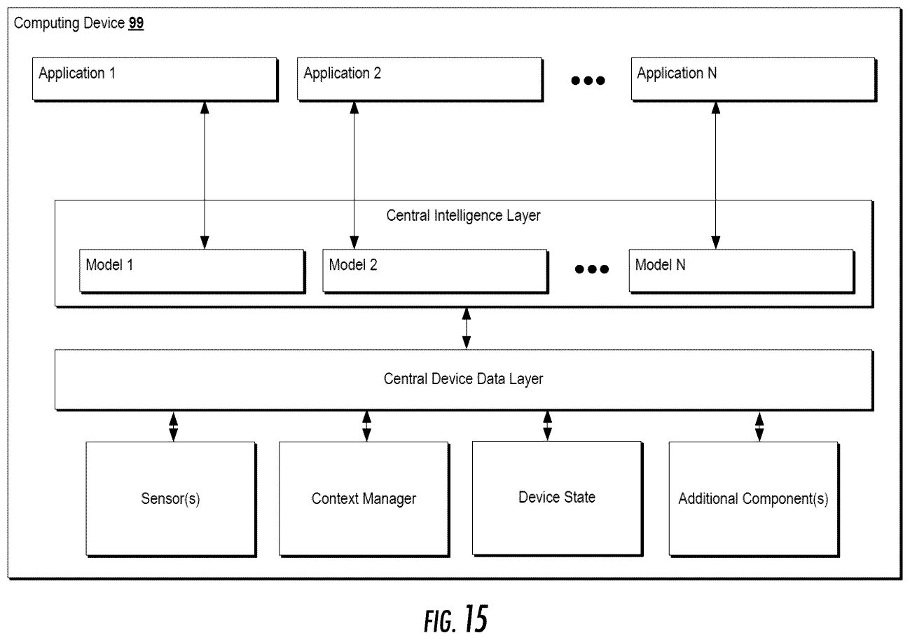

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
accessing, by a first agent of a plurality of agents, a current set of context data elements associated with a multi-agent communication session involving the plurality of agents;
generating, by the first agent, a first agent output data element of a first agent output based on the current set of context data elements, the first agent output comprising a sequence of multiple first agent output data elements decoded over a plurality of decoding iterations; and
before completion of the first agent output:
receiving, by the first agent, from one or more second agents of the plurality of agents, one or more data streams comprising one or more second agent output data elements of one or more second agent outputs generated by the one or more second agents of the plurality of agents;
updating, by the first agent, the current set of context data elements to include the one or more second agent output data elements; and
generating, by the first agent, one or more additional first agent output data elements of the first agent output based on the current set of context data.

2. The computer-implemented method of claim 1, wherein updating, by the first agent, the current set of context data elements to include the one or more second agent output data elements comprises:
inserting the one or more second agent output data elements into the current set of context data elements in a sequence according to a time of receipt of the second agent output data elements.

3. The computer-implemented method of claim 1, wherein updating, by the first agent, the current set of context data elements to include the one or more second agent output data elements comprises:
interleaving the one or more second agent output data elements with one or more of the first agent output data elements of the first agent output.

4. The computer-implemented method of claim 1, wherein the one or more second agents comprises two or more different agents and wherein updating, by the first agent, the current set of context data elements to include the one or more second agent output data elements comprises interleaving second agent output data elements received from the two or more different agents.

5. The computer-implemented method of claim 1, further comprising:
before the completion of the first agent output, streaming, by the first agent, the first agent output data element of the first agent output to one or more of the plurality of agents.

6. The computer-implemented method of claim 1, further comprising:
before the completion of the first agent output, updating a key-value (KV) cache based on the first agent output data element and the one or more second agent output data elements, wherein the KV cache is associated with the sequence of multiple first agent output data elements and a sequence of multiple second agent output data elements decoded over the plurality of decoding iterations.

7. The computer-implemented method of claim 1, further comprising:
grouping the one or more second agent output data elements of one or more second agent outputs based on an originating agent of the one or more second agents.

8. The computer-implemented method of claim 1, further comprising:
determining, based on a maximum length, a complete second agent output by the one or more second agents.

9. The computer-implemented method of claim 1, further comprising:
determining, based on a termination data element of the one or more second agent output data elements, a complete second agent output by the one or more second agents, wherein the termination data element is indicative of an end of a sequence of the one or more second agent output data elements.

10. A computing system comprising a first agent configured to participate in a multi-agent communication session involving the first agent and one or more second agents, the computing system configured to perform operations, the operations comprising:
accessing, by the first agent, a current set of context data elements associated with the multi-agent communication session;
initiating, by the first agent, decoding of a first agent output based on the current set of context data elements, wherein decoding of the first agent output comprises generating a sequence of multiple first agent output data elements; and
during decoding of the first agent output:
streaming, by the first agent, individual elements of the first agent output data elements to the one or more second agents as they are generated.

11. The computing system of claim 10, wherein the operations further comprise:
receiving, by the first agent, from one or more second agents, one or more data streams comprising one or more second agent output data elements of one or more second agent outputs generated by the one or more second agents.

12. The computing system of claim 11, wherein the operations further comprise:
updating, by the first agent, the current set of context data elements to include the one or more second agent output data elements.

13. The computing system of claim 12, wherein updating, by the first agent, the current set of context data elements to include the one or more second agent output data elements comprises:
inserting the one or more second agent output data elements into the current set of context data elements in a sequence according to a time of receipt of the second agent output data elements.

14. The computing system of claim 10, wherein streaming, by the first agent, individual elements of the first agent output data elements to the one or more second agents as they are generated comprises:
interleaving at least one individual element of the first agent output data elements.

15. The computing system of claim 10, wherein the operations further comprise:
during decoding of the first agent output:
updating a key-value (KV) cache based on the current set of context data elements and the first agent output data element and the sequence of multiple first agent output data elements.

16. The computing system of claim 10, wherein the individual elements of the first agent output data elements comprise a termination data element, wherein the termination data element is indicative of an end of a sequence of the first agent output data elements.

17. The computing system of claim 10, wherein accessing, by the first agent, a current set of context data elements associated with the multi-agent communication session comprises:
exchanging information with the one or more second agents, the information indicative of (i) a common task associated with the one or more second agents, and (ii) respective agents of the one or more second agents that are participating in the multi-agent communication session.

18. A computing system comprising a first agent configured to participate in a multi-agent communication session involving the first agent and one or more second agents, the computing system configured to perform operations, the operations comprising:
accessing, by the first agent, a current set of context data elements associated with the multi-agent communication session;
initiating, by the first agent, decoding of a first agent output based on the current set of context data elements, wherein decoding of the first agent output comprises generating a sequence of multiple first agent output data elements; and
during decoding of the first agent output:
receiving, by the first agent from the one or more second agents in one or more data streams, individual subsections of one or more second agent outputs generated by the one or more second agents; and
dynamically updating, by the first agent, a decoding trajectory of the first agent output based on the received individual subsections of the one or more second agent outputs.

19. The computing system of claim 18, wherein dynamically updating, by the first agent, the decoding trajectory of the first agent output comprises:
generating an additional sequence of multiple first agent output data elements.

20. The computing system of claim 18, wherein the operations further comprise:
during decoding of the first agent output:
streaming, by the first agent, individual elements of the sequence of multiple first agent output data elements to the one or more second agents as they are generated.
